(19) United States
(12) Patent Application Publication
(10) Pub. No.: US 2013/0136539 A1
(43) Pub. Date: May 30, 2013

(54) PAVING SYSTEM UTILIZING EMBEDDED MEASURING DEVICES

(71) Applicant: James Alvin AARDEMA, Plymouth, MN (US)

(72) Inventor: James Alvin AARDEMA, Plymouth, MN (US)

(21) Appl. No.: 13/308,458

(22) Filed: Nov. 30, 2011

(51) Int. Cl. E01C 7/00; E01C 23/07; G01L 5/00; E01C 21/00

(52) U.S. Cl. 404/75; 404/84.05; 73/862.55

(57) ABSTRACT

A method of controlling a paving process is disclosed. The method may include mixing at least one sensor within a paving material and dispensing the paving material at a desired location. The method may also include monitoring a wireless signal from the sensor during the paving process. The method may further include controlling the paving process based on the wireless signal.

### TECHNICAL FIELD

The present disclosure relates generally to a paving system, and more particularly, to a paving system utilizing embedded measuring devices.

### BACKGROUND

Preparation of roadways, building sites, embankments, and other surfaces often requires compaction to produce desired material properties. Compactors are employed to compact various paving materials such as, for example, soil, gravel, and an asphalt material. The desired degree of material compaction can vary based on the type of material being compacted and/or conditions of the material such as, for example, soil moisture content and asphalt temperature. Compaction levels are important for maintaining stability of the paving material. When undercompacted, paving surfaces lack sufficient strength to support traffic loads and are not durable. When overcompacted, asphalt and other paving materials can be permanently deformed. During a compaction process, the degree of material compaction can be measured and evaluated for conformity with job specifications.

Traditional methods for determining material compaction have included density measurements and physical testing. Density measurements are conducted using a specialized instrument, such as a nuclear density meter. Soil physical testing is performed by various methods such as by nuclear gauge, LWD, FWD, and by penetrometer. Although suitable for some applications, these methods can be cumbersome to apply to an entire project area. In addition, some methods also may result in physical destruction of the project surface when, for example, core samples are taken. Further, these methods may be time consuming as they are usually conducted separate from the compaction process.

An alternative system for monitoring compaction of a surface is described in U.S. Pat. No. 6,122,601 (“the '601 patent”) of Swanson et al. that issued on Sep. 19, 2000. The '601 patent describes a compactor having a compaction meter that takes into account the vibratory response of the compactor when determining compaction of a surface traversed by the compactor. The compactor has intrinsic vibrations from the vibratory mechanism of the compactor's drums that vibrate the compactor as it moves. The compaction meter assumes that, as the compacted material becomes more dense, the vibratory response of the compactor increases. The compaction meter of the '601 patent measures the vibratory response of the compactor and then correlates that response to the compaction level of the asphalt being compacted. The correlation is based on a mathematical model that must account for such parameters as the mass of the compactor, the acceleration of the compactor vibrations, pavement type, mix type, and base type, among others.

The system of the '601 patent may be limited in its accuracy. First, measurements made by the system may be affected by the vibratory response of the sub-base below the new asphalt layer. Second, the mathematical model makes assumptions and treats certain parameters as negligible in order to simplify the model. Because of these factors, among others, a mathematical model of asphalt density may not be as accurate as an actual measurement of asphalt density.

The disclosed system is directed to overcoming one or more of the problems set forth above and/or other problems of the prior art.

### SUMMARY

In one aspect, the present disclosure is directed to a method of controlling a paving process. The method may include mixing a sensor within a paving material and dispensing the paving material at a desired location. The method may also include monitoring a wireless signal from the sensor during the paving process. The method may further include controlling the paving process based on the wireless signal.

In another aspect, the present disclosure is directed to a sensor for use in a paving process. The sensor may include a shell configured to withstand a desired compaction force when embedded within a paving material and a sensing element encapsulated within the shell and configured to sense a paving parameter of the paving material. The sensor may also include a processing module connected to the sensing element and an antenna connected to the processing module and an antenna configured to broadcast a signal representative of the paving parameter.

In yet another aspect, the present disclosure is directed to a paving system. The paving system may include at least one sensor and a paving machine configured to dispense a mixture of paving material and the at least one sensor on a surface. The paving system may also include a compactor configured to compact the mixture dispensed by the paving machine and a reader configured to communicate with the at least one sensor. The paving system may further include a controller in communication with the reader and configured to affect operation of the compactor based on an output of the reader.

### BRIEF DESCRIPTION OF THE DRAWINGS

FIG. 1 is a diagrammatic side view illustration of a paving system according to one embodiment;

FIG. 2 is a pictorial illustration of an exemplary disclosed sensor that may be used with the paving system of FIG. 1;

FIG. 3 is a pictorial illustration of another exemplary disclosed sensor that may be used with the paving system of FIG. 1;

FIG. 4 is a flowchart depicting an exemplary disclosed method performed by the paving system of FIG. 1; and

FIG. 5 is a flowchart depicting another exemplary disclosed method performed by the paving system of FIG. 1.

### DETAILED DESCRIPTION

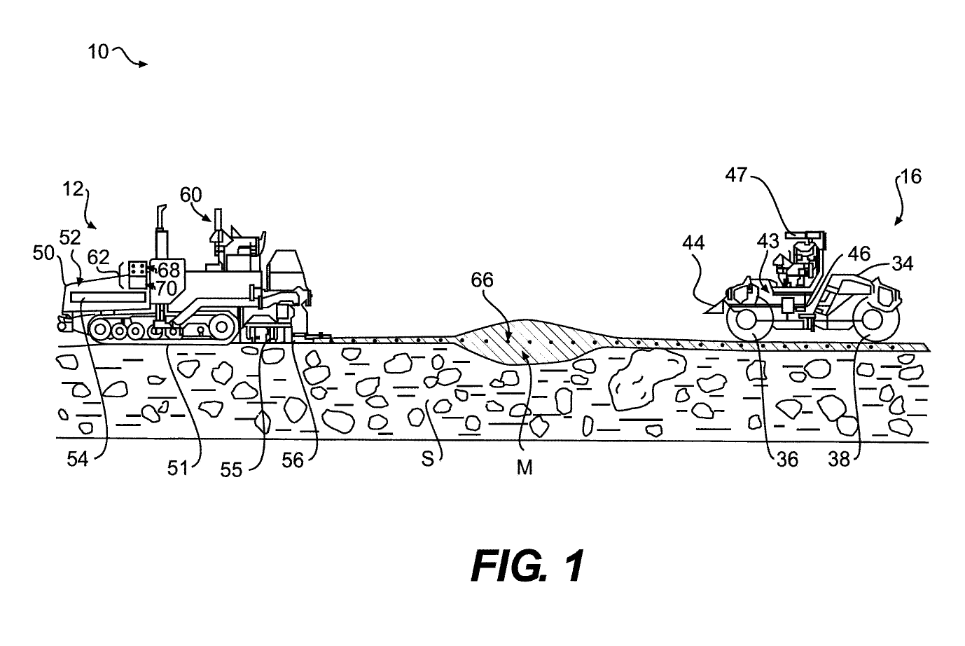

Referring to FIG. 1, there is shown a paving system 10 according to one exemplary embodiment. Paving system 10 may include a plurality of different machines, and in the illustrated embodiment includes a paving machine 12 and a compactor 16. The various machines of paving system 10 are shown approximately as they might appear during paving of a paving material M on a sub-grade S. Paving machine 12 may travel across sub-grade S and dispense paving material M, which may be subsequently compacted by compactor 16. As further described herein, paving system 10 may be configured to control compactor 16 and, optionally, additional compactors to optimize paving smoothness, depth, and/or a compaction level of paving material M.

Paving machine 12 may generally include a frame 50 configured to support a hopper 52 for temporarily storing paving material M. In the disclosed embodiment, paving material M may be an asphalt material comprising an aggregate and a binder. It should be noted, however, that other materials may alternatively be utilized, such as soil, gravel, and other known paving materials. Paving machine 12 may further include a feeder conveyor 54 and auger(s) 55 configured to dispense paving material M from hopper 52 onto sub-grade S for conventional leveling, preliminary compacting, thickness control, etc., via a screed 56. Paving machine 12 may further include a plurality of ground-engaging elements 51, such as wheels or tracks configured to propel paving machine 12, and an operator station 60.

Hopper 52 may have an open top to receive paving material M from any known mechanism, for example, from a dump truck. Hopper 52 may also have an open bottom to allow feeder conveyor 54 and auger 55 to dispense material M out of hopper 52 and onto sub-grade S. Hopper 52 may be fixedly integrated into frame 50 of paving machine 12. The side walls of hopper 52 may be fixed or alternatively may be pivotable to allow for a maximum capacity during paving processes and a minimum width during transport.

One or more feeder conveyors 54 may be connected to the bottom of hopper 52. If multiple feeder conveyors are used, they may be placed side-by-side and run parallel to one another. Feeder conveyor 54 may transport paving material M from hopper 52 to a rear of paving machine 12, where paving material M may be dispensed behind paving machine 12 onto sub-grade S and moved across the front of screed 56 by auger 55.

Screed 56 may be attached at the rear of paving machine 12 and may be configured to level, shape, and/or position paving material M dispensed by feeder conveyor 54 and auger 55. Typically, paving material M may be dispensed via paving machine 12 at an irregular thickness according to the surface profile of sub-grade S. The surface profile of the dispensed paving material M may vary inversely with the profile of sub-grade S. For example, relatively thinner sections of paving material M may be dispensed over elevated portions of sub-grade S and relatively thicker sections of paving material M may be dispensed over depressions in sub-grade S. The height of screed 56 may be altered in response to these variations according to mechanisms known in the art.

Paving machine 12 may also include a mixing device 62 configured to mix a supply of sensors 66 with paving material M before screed 56 shapes paving material M. Mixing device 62 may include a sensor hopper 68 and a rate controller 70.

Sensor hopper 68 may be any container configured to temporarily hold a plurality of sensors. Sensor hopper 68 may feed sensors 66 to rate controller 70, which may regulate the flow of sensors 66 into paving material M. Rate controller 70 may regulate the flow of sensors 66 based on, for example, the forward speed of paving machine 12. It should be noted, however, that rate controller 70 may alternatively utilize other mechanisms to dispense sensors 66 or that rate controller 70 may be subject to manual operation by a user, if desired. Because sensors 66 may be mixed into paving material M in a rate-controlled manner, their distribution along sub-grade S can be controlled to be relatively uniform, such that the spacing between each embedded sensor 66 is relatively uniform. For example, mixing device 62 may mix sensors 66 within paving material M such that a space between consecutive sensors 66 in a strip of paving material M is about 5-10 feet. It should be noted, however, that other spacing distances may alternatively be used that will allow a user to accurately determine compaction at any point along a single strip or multiple strips of paving material M.

Mixing device 62 may be configured to mix sensors 66 with paving material M in hopper 52 at feeder conveyor 54, or at any time before paving material M reaches screed 56. It should be noted, however, that sensors 66 could alternatively be mixed with paving material M prior to placement into hopper 52, or may be mixed by auger 55, if desired.

Compactor 16 may include a frame 34, having at least a front compacting drum 36. In the disclosed embodiment, compactor 16 also includes a rear compacting drum 38 coupled to frame 34. Compactor 16 may further include a controller 43, including a reader 44 configured to communicate with sensors 66 embedded within paving material M. It should be noted, however, that controller 43 may not be integral with compactor 16, if desired. Controller 43 may further include an electronic control unit 46. Controller 43 may also be operatively connected to a GPS device 47. Reader 44 may be configured to send wireless signals to embedded sensors 66, and to receive wireless signals back from embedded sensors 66. Alternatively, reader 44 may only be configured to receive wireless signals from embedded sensors 66. In one exemplary embodiment, the wireless signal may be an RF signal and reader 44 may be an RFID reader. It should be noted, however, that another suitable form of wireless signal and reader may alternatively be used.

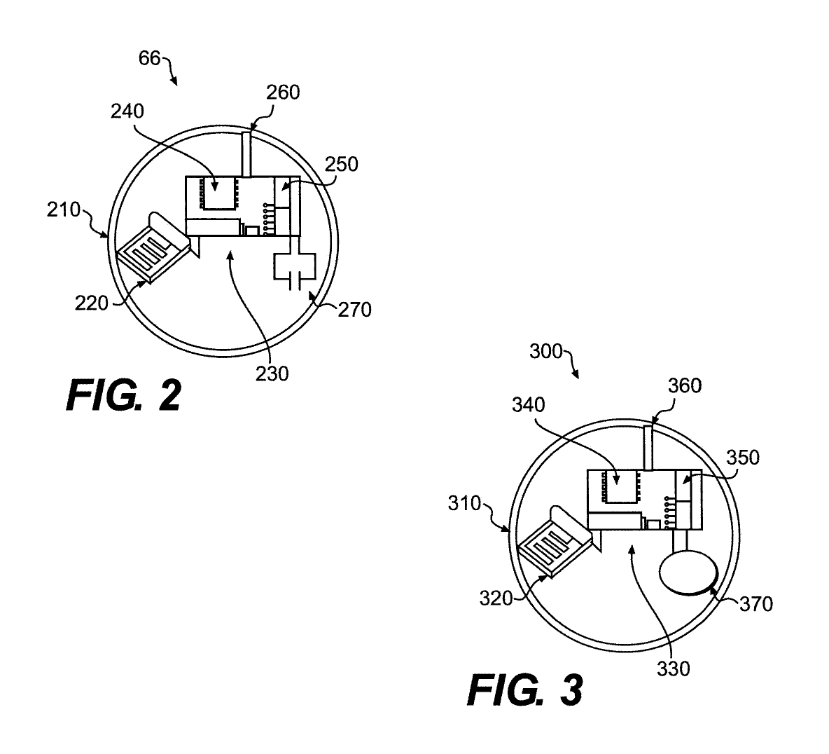

Referring to FIG. 2, there is shown sensor 66 according to an exemplary embodiment. Sensor 66 may be a wireless device and may include a shell 210, at least one sensing element 220, and an integrated circuit 230 connected to sensing element 220. Integrated circuit 230 may include a processing module 240, a memory module 250, an antenna 260, and a passive energy storage device 270. The size of sensor 66 will normally be related to the size of material M. That is, if sensor 66 is too large, it may leave significant voids and negatively affect the compaction process. In the disclosed embodiment, sensor 66 may have a diameter of about 0.1 to 5 cm. It should be noted, however, that another suitable diameter may alternatively be used. Shell 210 may be configured to encapsulate sensing element 220, integrated circuit 230 and to withstand at least a minimum compaction force when embedded within paving material M. The minimum compaction force may greater than a desired compaction level of paving material M such as, for example approximately 400 kPa. It should be noted, however, that other compaction levels may alternatively be utilized depending upon the specific paving process and paving material. Shell 210 may be made from glass, high-temperature plastic, metal, cement, or another suitable material.

Sensing element 220 may be capable of sensing a paving parameter that can be affected by or have an affect on a compaction process performed on paving material M. Sensing element 220 may be, for example, a thermocouple or thermistor capable of measuring a paving parameter, such as the temperature of the surface of sensor 66. The sensed temperature would be equivalent to the core temperature of paving material M dispensed by paving machine 12 and subsequently compacted by compactor 16. Sensing element 220 may alternatively be a strain gauge capable of measuring stress-strain on the exterior surface of sensors 66, or embody a rupture disc that breaks open a circuit indicating a pressure level has been exceeded. If rupture discs are utilized, sensors 66 may include multiple rupture discs designed to break open at varying pressure levels. Stress-strain sensed by sensing element 220 may be a paving parameter that is directly indicative of a compaction level of paving material M. Sensing element 220 may also be a device capable of sensing a moisture level at the surface of the sensor 66 when paving material M is a soil material.

Processing module 240 may be a single processing device or a plurality of processing devices. The processing module 240 may be a microprocessor, micro-controller, digital signal processor, microcomputer, central processing unit (CPU), field programmable gate array, programmable logic device, state machine, logic circuitry, analog circuitry, digital circuitry, or alternately any device that can manipulate analog or digital signals. Processing module 240 may process a signal from reader 44 and execute a set of operational instructions, such as converting paving parameters sensed by sensing element 220 into data to be broadcast back to reader 44 through antenna 260. The data representing paving parameters may then be used to affect the paving process.

Memory module 250 may be a single memory device, a plurality of memory devices, and/or embedded circuitry of the processing module 240. The memory module 250 may be a read-only memory, random access memory, volatile memory, non-volatile memory, static memory, dynamic memory, flash memory, cache memory, and/or any device that stores digital information. Memory module 250 may store operational instructions for processing module 250 and may store data representing paving parameters sensed by sensing element 220. Memory module 250 may also store unique identification information specific to each individual sensor 66 or to a batch of individual sensors 66. For example, the unique identification information may be a unique alphanumeric code.

Antenna 260 may include one or more mono-pole or dipole antennas and may further include a transmission line, an impedance matching circuit, and/or a transformer balun. It should be noted, however, that other known configurations of an antenna may alternatively be utilized. Antenna 260 may be in electrical communication with processing module 240 and may be configured to receive a signal from reader 44, as well as transmit a signal back to reader 44. Antenna 260 may also broadcast unique identification information in addition to the sensed paving parameters.

In some embodiments, sensor 66 may not have an on-board active power source. In particular, sensor 66 may be known as a passive device having a passive energy source 270, such as a capacitor. Passive energy source 270 may be powered by electromagnetic waves sent by reader 44 and received by antenna 260. Because sensor 66 does not require an active power source, sensor 66 may have relatively long useful life. Additionally, a production cost for sensor 66 may be low.

Referring to FIG. 3, there is shown a sensor 300 according to another exemplary embodiment. Sensor 300 may also be an encapsulated device similar to sensor 66 of FIG. 2. Shell 310, sensing element 320, integrated circuit 330, processing module 340, memory module 350, and antenna 360 may be substantially similar to the components described above with respect to sensor 66. In contrast to the embodiment of FIG. 2, however, sensor 300 may have an on-board power source 370.

On-board power source 370 may be a battery, and sensor 300 may be known as an active device. On-board power source 370 may allow sensor 300 to have a greater broadcast range, more processor power, and more memory capacity. It is noted, however, that on-board power source 370 may be used in conjunction with a passive energy storage device, such as a capacitor, in order to improve the energy utilization of sensor 300.

### INDUSTRIAL APPLICABILITY

The disclosed system may be applicable to any paving process where obtaining proper compaction levels of the paving material, or performing compaction at optimal temperatures, is important. The system is particularly applicable to paving applications where it is desirable to obtain real-time, accurate, and/or comprehensive measurements of compaction levels during and after dispensing of the paving material. Additionally, time and fuel costs may be reduced because paving processes may be stopped before unnecessary passes are made. An exemplary paving process will now be described.

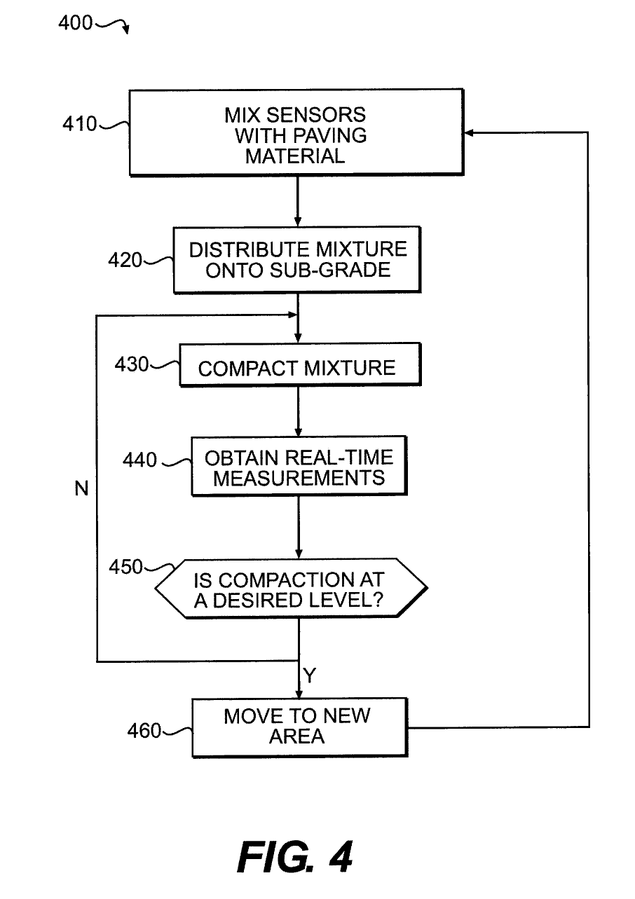

There is shown a flowchart 400 in FIG. 4 illustrating a paving process according to an exemplary embodiment. The process of flowchart 400 may begin at Control Block 410, where mixing device 62 of paving machine 12 mixes sensors 66 or 300 with paving material M. As indicated above, mixing may occur at any location within paving machine 12, or may alternatively occur before paving material M is loaded into hopper 52.

From Control Block 410, the process may proceed to Control Block 420 where the combined mixture of paving material M and sensors 66 or 300 is transported from hopper 52 by feeder conveyor 54 and auger 55 and dispensed at a desired location, such as on sub-grade S. Sensors 66 or 300 may be distributed such that there is a relatively uniform spacing between consecutive sensors dispensed in a strip of paving material M. The distribution and spacing may be selected so that a user can accurately determine the level of compaction for the entirety of a project area such as a roadway, building site, embankment, or the like. Alternatively, sensors 66 or 300 may be dispensed only at specified test locations within paving material M on sub-grade S.

The deposited mixture may then undergo a paving process in Control Block 430, for example, by compactor 16. Compactor 16 may make one or more passes over a given strip of material M dispensed by paving machine 12. Compactor 16 may be operated either via autonomous or operator control in order to achieve a desired set of paving parameters. The paving parameters may be based upon a set of paving specifications and compactor specifications. Paving specifications might include the composition, particulate size, and desired compaction level of paving material M. Compactor specifications might include compactor speed, travel direction, and other factors relating to energy transfer between compactor 16 and paving material M. It should be noted, however, that any suitable paving specifications and compactor specifications may alternatively be used to determine a desired paving parameter.

Both during and after the paving process is performed at Control Block 430, real-time measurements may be obtained at Control Block 440 by monitoring for a wireless signal from the embedded sensors 66 or 300. If passive sensors 66 are embedded into paving material M, reader 44 may send out a signal, which is received by antenna 260 and processed by processing module 240. Processing module 240 may then determine an output from sensing element 220, which may be stress-strain, pressure, temperature, moisture level, and/or any other paving parameter useful to assess paving processes. The output of sensing element 220 may then be broadcast by integrated circuit 230 through antenna 260. Integrated circuit 230 may also broadcast unique identification information along with the output from sensing element 220. Alternatively, if active sensors 300 are embedded in paving material M, integrated circuit 330 may actively broadcast output from sensing element 320 to reader 44 on compactor 16, with or without first receiving a signal from reader 44. It should be noted, however, that even if active sensors 300 are embedded in paving material M, antenna 360 may still respond to a signal broadcast by reader 44. Additionally, reader 44 may not be turned on until after paving machine 12 is a suitable distance away from compactor 16, if desired, to help avoid interference with sensors 66 still present on paving machine 12.

Real-time measurements from sensors 66 or 300 may correspond to an actual level of compaction of paving material M. The stress-strain measured at the surface of sensors 66 or 300 may be equivalent to the compaction of paving material M. Because of air voids in paving material M, paving material M becomes more compact after each subsequent pass of compactor 16. A desired compaction level of paving material M may occur after one or more passes by compactor 16 over a strip of paving material M dispensed by paving machine 12. After a desired compaction level such as 400 kPa is achieved, it is possible that subsequent passes may result in overcompaction of paving material M. It should be noted, however, that other desired compaction levels may alternatively be used based upon the specific paving process and/or paving material. Real-time measurements may allow a user or controller 43 to determine a precise point when a compaction level of paving material M has reached a desired threshold so that the paving process may be determined to be complete. That is, controller 43 may affect operation of the at least one compacting drum of compactor 16 based on an output of reader 44. For example, controller 43 may alter the speed, vibration level, number of passes, or direction of compactor 16.

Alternatively or additionally, other paving parameters may be utilized to affect the paving process. For example, knowledge of core temperature may affect when compaction may be performed. In one exemplary embodiment, compaction may initially be performed while paving material M is above a first threshold temperature, for example 190° F. While paving material M is below a first threshold temperature and above a second threshold temperature, for example 135° F., compaction may not be performed. Compaction may be re-initiated when paving material M cools below the second threshold temperature. It should be noted, however, that other suitable values for the first and second threshold temperatures may alternatively be used depending on the specific paving process and paving material.

Further, residual moisture can cause performance issues in soil materials. A user may determine that a moisture content of a soil material is beyond an acceptable desired threshold. In response, a user may determine that a drying process may be required or that the soil material may require re-mixing. Still further, moisture level may be used to determine when irrigation of the soil material may be appropriate.

Control of the paving process may be based on the output of the wireless signal. For example, based on the real-time measurements obtained in Control Block 440, a determination may be made at Control Block 450 whether a desired compaction level or paving parameter has been achieved. If a desired compaction level is achieved in the vicinity of a given sensor 66 or 300, the paving process may be determined to be complete in that vicinity and compactor 16 may move to a new area or finish at Control Block 460. This determination may be made by an operator based on the data from the embedded sensors 66 or 300. Alternatively, the determination may be made by control system 43. For example, control system 43 may reference a desired compaction level based upon paving specifications and compare the desired compaction level with an actual compaction level output by sensors 66 or 300. Additionally, compaction level or paving process data from sensors 66 or 300 may be correlated with GPS data from GPS device 47 to monitor and store the sensed data versus time and location. This data may be used to show a contracting agency that the desired compaction level has been reached and that the desired paving process has been performed. If a desired compaction level is not reached at Control Block 450, the process may return to execute Control Blocks 430-450 until the desired compaction level is achieved.

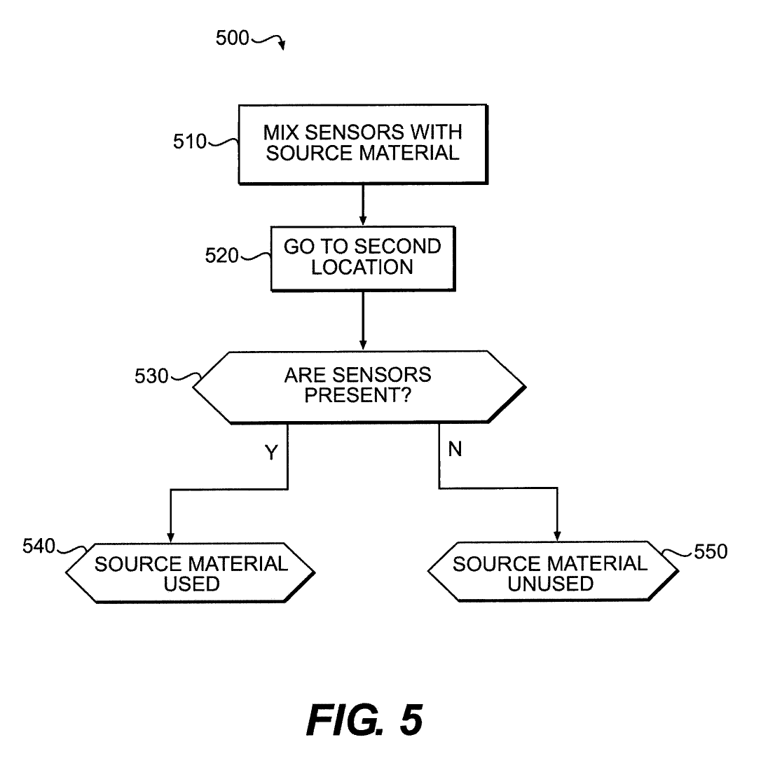

Sensors 66 or 300 may also be used in a different manner, if desired, to track a source location of material used in the paving process. There is shown a flowchart 500 in FIG. 5 illustrating a material tracking process according to one embodiment. The material tracking process may be useful in applications where it is desired to verify the source of a particular material used in a paving process. For example, a customer may fear that after selecting and paying for a premium source material, that a supplier will instead transport an inferior or substitute material to a second location, such as a project area. Absent direct supervision of source material transport from the source location to the second location, a customer may have limited mechanisms to verify that the originally selected source material was delivered and used in a paving process at the second location. The tracking process may start at Control Block 510 where sensors 66 or 300 may be dispensed in a source material at a source location, such as, a mineral aggregate source, a rock source, soil, top soil, or any other suitable source material used in compaction and paving processes. Sensors 66 or 300 may be mixed uniformly or randomly by hand or by any suitable mixing device. The sensors 66 or 300 may include unique identification information.

The process may proceed to Control Block 520 where signals from the sensors 66 or 300 are monitored at the second location at which a paving process is performed with the source material. For example, wireless signals from the sensors embedded in pavement formed from the source material may be monitored at Control Block 530 at the second location. At Control Block 530, by monitoring for a signal from sensors 66 or 300, a user may be able to determine a paving process characteristic. For example, if a signal from at least one of the sensors 66 or 300 with unique identification information is detected in pavement at the second location, a user may know with confidence that the source material was used in the paving process at the second location, and the tracking process can end at Control Block 540. If no wireless signals are detected from the sensors with unique identification information, then a user may suspect that the source material was not used in the paving process at the second location, and the tracking process may end at Control Block 550. Since sensors 66 or 300 contain unique identification information, a supplier may be prevented from misleading a customer by inserting any given sensor 66 or 300 into a substituted material. The material tracking process may alternatively monitor for wireless signals from the sensors upon delivery of the source material at the second location. Because substitute materials may have different properties, performance standards may not be met if substitute materials are inadvertently used in a paving process. The material tracking process may assist in performance standard verification and may prevent supplier fraud.

It will be apparent to those skilled in the art that various modifications and variations can be made to the disclosed paving system without departing from the scope of the disclosure. Other embodiments of the paving system will be apparent to those skilled in the art from consideration of the specification and practice of the paving system disclosed herein. It is intended that the specification and examples be considered as exemplary only, with a true scope of the disclosure being indicated by the following claims and their equivalents.

What is claimed is:

1. A method of controlling a paving process, comprising:
mixing a sensor within a paving material;
dispensing the paving material at a desired location;
monitoring a wireless signal from the sensor during the paving process; and
controlling the paving process based on the wireless signal.

2. The method of claim 1, wherein the paving material is an asphalt material.

3. The method of claim 2, wherein the paving process includes compaction of the paving material.

4. The method of claim 1, wherein the wireless signal is indicative of a paving parameter of the paving material affected by the paving process.

5. The method of claim 4, wherein the paving parameter is a temperature of the paving material.

6. The method of claim 4, wherein the paving parameter is a compaction level of the paving material.

7. The method of claim 6, wherein the paving process is completed when the compaction level reaches approximately 400 kPa.

8. The method of claim 6, wherein the compaction level of the paving material is correlated with GPS data.

9. The method of claim 1, wherein the sensor includes a power source.

10. A sensor for use in a paving process, comprising:
a shell configured to withstand a compaction force when embedded within a paving material;
a sensing element encapsulated within the shell and configured to sense a paving parameter of the paving material;
a processing module connected to the sensing element; and
an antenna connected to the processing module and configured to broadcast a signal representative of the paving parameter.

11. The sensor of claim 10, wherein the paving parameter is a temperature of the paving material.

12. The sensor of claim 10, wherein the paving parameter is a compaction level of the paving material.

13. The sensor of claim 10, wherein the compaction force is greater than approximately 400 kPa.

14. The sensor of claim 10, wherein the antenna is configured to broadcast an RF signal.

15. The sensor of claim 10 further including a power source configured to provide power to the sensing element, the processing module, and the antenna.

16. A paving system, comprising:
at least one sensor;
a paving machine configured to dispense a mixture of paving material and the at least one sensor on a surface;
a compactor configured to compact the mixture dispensed by the paving machine;
a reader configured to communicate with the at least one sensor; and
a controller in communication with the reader and configured to affect operation of the compactor based on an output of the reader.

17. The paving system of claim 16, wherein the controller is further configured to determine a compaction level of the paving material based on the output of the reader.

18. The paving system of claim 17, wherein the controller is further configured to determine completion of a paving process when the compaction level has reached a desired threshold.

19. The paving system of claim 18, wherein the desired threshold is approximately 400 kPa.

20. The paving system of claim 17, including a GPS device operatively connected to the controller, the controller being further configured to correlate the compaction level of the paving material to GPS data from the GPS device.
